(19) United States
(12) Patent Application Publication
(10) Pub. No.: US 2026/0111184 A1
(43) Pub. Date: Apr. 23, 2026

(54) SYSTEMS AND METHODS FOR SUBMISSION OF A SOFTWARE APPLICATION TO A THIRD PARTY DISTRIBUTION PLATFORM

(71) Applicant: Engineer.ai Corp., Salt Lake City, UT (US)

(72) Inventors: Sachin Dev Duggal, Salt Lake City, UT (US); Rohan Patel, London (GB); Utsav Preet, Salt Lake City, UT (US)

(73) Assignee: Engineer.ai Corp., Salt Lake City, UT (US)

(21) Appl. No.: 18/922,378

(22) Filed: Oct. 21, 2024

(51) Int. Cl. G06F 8/35; G06F 8/38

(52) U.S. Cl. CPC G06F 8/35; G06F 8/38

(57) ABSTRACT

Systems, methods, and a computer readable storage medium are disclosed for submission of a software application to one or more application stores. The method includes receiving one or more inputs from a user and retrieving buildcard information of the software application based on the received one or more inputs. The method further includes determining functions and properties of the software application based on the buildcard information and generating the metadata for the software application based on the determined functions and properties.

### FIELD OF THE INVENTION

This disclosure relates to software automation, machine learning AI, and project management.

### BACKGROUND

Developing a software application requires a lot of experience from an initial discussion with a customer about the application to be developed to the final stage of software application development. The amount of time required for developing the software application generally varies from months to many years. Upon developing the software application, the software application needs to be submitted manually to multiple application stores in order for an end-user to access the software application. However, the manual process of submitting the software application is time-consuming and prone to errors.

Accordingly, there is a need in the art to provide a platform that enables the automatic submission of the software application to one or more application stores.

### SUMMARY

Disclosed are methods, systems, and computer readable storage mediums for generating metadata for a software application. The method includes receiving one or more inputs from a user and retrieving buildcard information of the software application based on the received one or more inputs. The method further includes determining functions and properties of the software application based on the buildcard information and generating the metadata for the software application based on the determined functions and properties.

### BRIEF DESCRIPTION OF THE DRAWINGS

FIG. 1 is a software building system illustrating the components that may be used in an embodiment of the disclosed subject matter.

FIG. 2 is a schematic illustrating an embodiment of the of the spec builder in accordance with a described implementation of the disclosed subject matter.

FIG. 3 is a schematic illustrating an embodiment of interactor in accordance with a described implementation of the disclosed subject matter.

FIG. 4 is a schematic illustrating an embodiment of the management components in accordance with a described implementation of the disclosed subject matter.

FIG. 5 is a schematic illustrating an embodiment of the expert evaluation system in accordance with a described implementation of the disclosed subject matter.

FIG. 6 is a schematic illustrating an embodiment of an assembly line and surfaces of the disclosed subject matter.

FIG. 7A is a schematic for an embodiment of a run engine of the disclosed subject matter.

FIG. 7B is a schematic for an embodiment of a building block that may be implemented in the disclosed subject matter.

FIG. 7C is a schematic for an embodiment of an adapter that may be implemented in the disclosed subject matter.

FIG. 8 is a schematic illustrating an embodiment of the run entities of the disclosed subject matter.

FIG. 9 is a schematic diagram of a metadata generator system in an embodiment of the disclosed subject matter.

FIG. 10 is an example user interface associated with a user device to develop the software application.

FIG. 11 is a flow diagram for an embodiment of the disclosed subject matter for a process of submitting a software application to one or more application stores.

FIG. 12 is a flow diagram for an embodiment of the disclosed subject matter for a process of generating metadata for the software application.

FIG. 13 is a flow diagram for another embodiment of the disclosed subject matter for a process of generating metadata for the software application.

FIG. 14 is a schematic illustrating the computing components that may be used to implement various features of embodiments described in the disclosed subject matter.

FIG. 15 is an example user interface associated with a user device to auto-fill the submission form associated with one of the application stores.

### DETAILED DESCRIPTION

The disclosed subject matter is a method, system, and computer readable storage medium for submission of a software application to one or more application stores. An embodiment of the disclosed metadata generator system includes receiving input from a user indicating the desire to publish the software application. The metadata generator system further includes determining requirements to submit the software application to the one or more application stores based on the received one or more inputs and generating metadata for the software application based on the determined requirements. The metadata generator system also includes submitting the software application to the one or more application stores based on the generated metadata.

In various embodiments, generating the metadata for the software application includes analyzing one or more attributes of the software application. The one or more attributes comprise at least one of: initial inputs provided by a client to develop the software application, one or more documents provided by the client, feedback from the client during the software application development process, and source codes related to the software application.

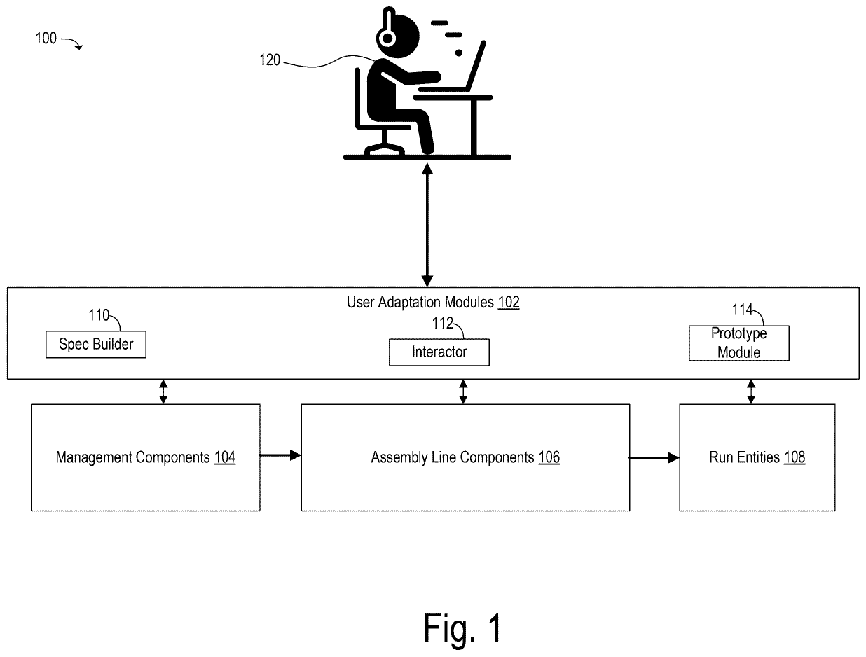

Referring to FIG. 1, FIG. 1 is a schematic of a software building system 100 illustrating the components that may be used in an embodiment of the disclosed subject matter. The software building system 100 is an AI-assisted platform that comprises entities, circuits, modules, and components that enable the use of state-of-the-art algorithms to support producing custom software.

A user 120 may leverage the various components of the software building system 100 to quickly design and complete a software project. The features of the software building system 100 operate AI algorithms where applicable to streamline the process of building software. Designing, building, and managing a software project may all be automated by the AI algorithms.

To begin a software project, an intelligent AI conversational assistant may guide users in the conception and design of their idea. Components of the software building system 100 may accept plain language specifications from a user 120 and convert them into a computer-readable specification that can be implemented by other parts of the software building system 100. Various other entities, modules, and components of the software building system 100 may accept the computer-readable specification or build card to automatically implement the computer-readable specification and/or manage the implementation of the computer-readable specification.

The embodiment of the software building system 100 shown in FIG. 1 includes user adaptation modules 102, management components 104, assembly line components 106, and run entities 108. The user adaptation modules 102 guide a user during all parts of a project from the idea conception to full implementation. User adaptation modules 102 may intelligently link a user to various entities of the software building system 100 based on the specific needs of the user.

The user adaptation modules 102 may include spec builder 110, an interactor 112 system, and the prototype module 114. They may be used to guide a user through the process of building software and managing a software project. Spec builder 110, the interactor 112 system, and the prototype module 114 may be used concurrently and/or linked to one another. For instance, spec builder 110 may accept user specifications that are generated in an interactor 112 system.

The prototype module 114 may utilize computer-generated specifications that are produced in spec builder 110 to create a prototype for various features. Further, the interactor 112 system may aid a user in implementing all features in spec builder 110 and the prototype module 114. The prototype module 114 may use a machine learning algorithm to select a most likely starting screen for each prototype. Thus, a user may select one or more features, and the prototype module 114 may automatically display a prototype of the selected features.

The prototype module 114 can automatically create an interactive prototype for features selected by a user. For instance, a user may select one or more features and view a prototype of one or more features before developing them. The prototype module 114 may determine feature links to which the user's selection of one or more features would be connected. In various embodiments, a machine learning algorithm may be employed to determine the feature links. The machine learning algorithm may further predict embeddings that may be placed in the user-selected features.

An example of the machine learning algorithm may be a gradient boosting model. A gradient boosting model may use successive decision trees to determine feature links. Each decision tree is a machine learning algorithm in itself and includes nodes that are connected via branches that branch based on a condition into two nodes. Input begins at one of the nodes whereby the decision tree propagates the input down a multitude of branches until it reaches an output node. The gradient boosted tree uses multiple decision trees in a series. Each successive tree is trained based on errors of the previous tree and the decision trees are weighted to return best results.

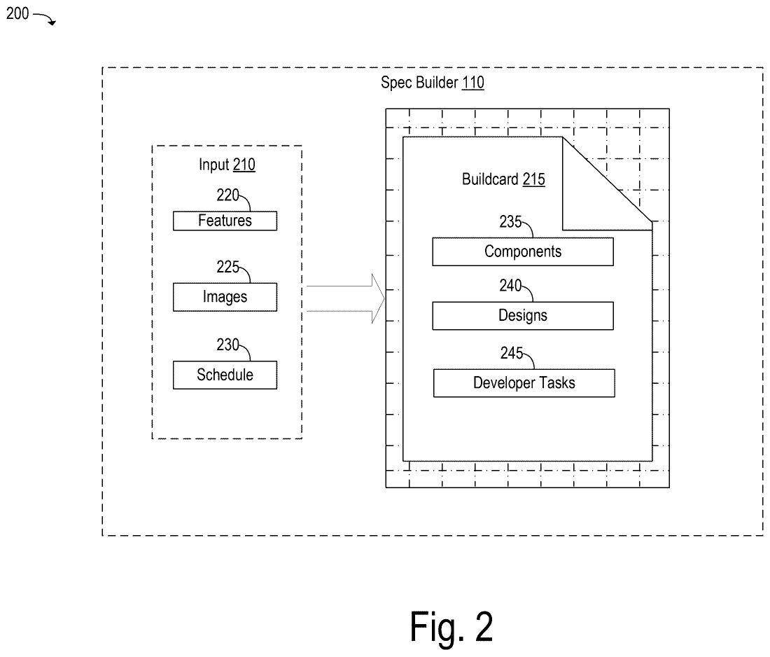

Referring to FIG. 2, FIG. 2 is a schematic 200 illustrating an embodiment of the spec builder 110 in accordance with a described implementation of the disclosed subject matter. Spec builder 110 converts input 210, such as user-supplied specifications, into specifications that can be automatically read and implemented by various objects, instances, or entities of the software building system 100. The machine-readable specification may be referred to herein as a buildcard 215. In an example of use, spec builder 110 may accept a set of features, platforms, etc., as input 210 and generate a machine-readable specification for that project.

Spec builder 110 may further use one or more machine learning algorithms to determine a cost and/or timeline for a given set of features. In an example of use, specification builder 110 may determine potential conflict points and factors that will significantly affect the cost and timeliness of a project based on training data. For example, historical data may show that a combination of various building block components creates a data transfer bottleneck. Spec builder 110 may be configured to flag such issues.

In an exemplary embodiment, a user may provide input 210, such as a plurality of features 220 to the spec builder 110. The spec builder 110 uses the features 220 to determine various components and designs 240 for a software application. For example, a user may provide that a software application should have a login feature. The spec builder 110 may determine that the login feature requires multiple components 235 and one or more designs 240 to implement the login feature.

The components 235 may comprise various functions, modules, classes, libraries, drivers, or the like that are used to code a software application. In various embodiments, the components 235 may comprise building block components as described below. The spec builder 110 may further generate one or more developer tasks 245 that would need to be completed to implement the login feature.

For example, one or more of the components 235 that were determined by the spec builder 110 may need to be custom built by a developer. One or more tasks will be generated by the spec builder to complete the one or more components 235 that need to be custom built. Each of these developer tasks 245 may be generated such that a skilled developer can read the developer task and follow it to build the component 235.

In various embodiments, each developer task may be written in such a way that an automated system may read the developer task 245 to develop the component 235 or design 240 for the software application. For example, the buildcard 215 may comprise a machine-readable specification and can be used as input for an automated system that generates components, designs, user interfaces, or the like for a software application based on the buildcard 215.

Likewise, the spec builder 110 may determine that one or more designs 240 should be implemented to complete the login feature. A design may comprise an organization of elements that are displayed on a screen for an end user. An end user, as described herein, may be an individual who is intended to use the completed software application. For example, a design for a login may comprise various screen elements that prompt an end user to enter a username and a password. The design 240 may specify any changes to a display as a software application is used. In the login feature example, the design 240 may determine what happens to a screen after an end user enters the username and password.

In various embodiments, a user may provide various images 225 to the spec builder 110. Spec builder 110 may leverage the images 225 to generate the designs 240. In an exemplary embodiment, a user may provide a sketch of various screens representing the user's vision of an operating software application. The spec builder 110 may generate designs 240 that approximate the user provided sketches.

In various embodiments, a user may provide a timeline or schedule 230 to the spec builder 110. The spec builder may use the schedule 230 to generate the developer tasks 245. In various embodiments, the spec builder 110 may split developer tasks 245 to accommodate a schedule 230. For example, a developer task that would normally be allocated to two developers, may be instead split among six developers to accommodate an aggressive schedule to develop a software application more quickly.

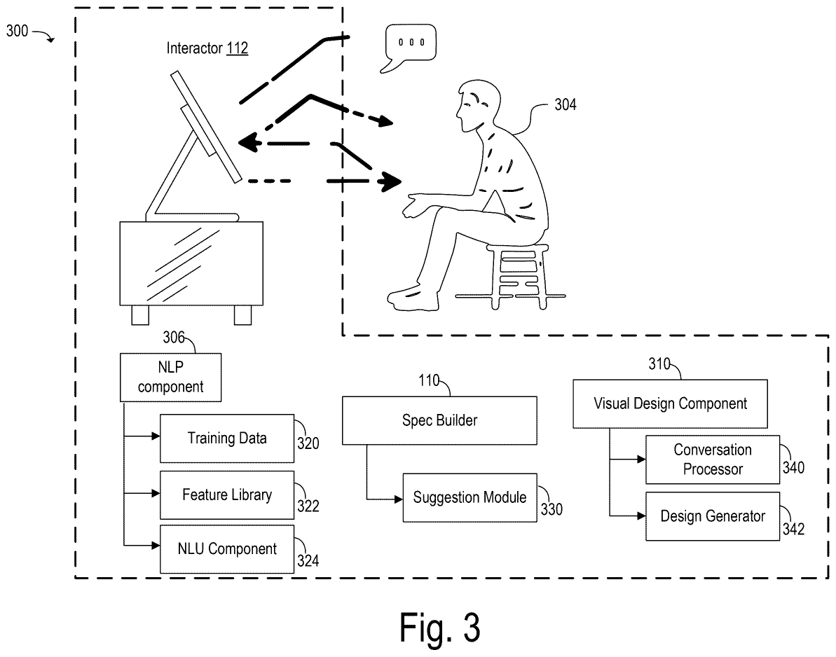

Referring to FIG. 3, FIG. 3 is a schematic 300 illustrating an embodiment of interactor 112 in accordance with a described implementation of the disclosed subject matter. The interactor 112 system is an AI powered speech and conversational analysis system. It converses with a user 304 with a goal of aiding the user 304. In one example, the interactor 112 system may ask the user 304 a question to prompt the user to answer about a relevant topic. For instance, the relevant topic may relate to a structure and/or scale of a software project the user wishes to produce. The interactor 112 system makes use of natural language processing (NLP) to decipher various forms of speech including comprehending words, phrases, and clusters of phases In an exemplary embodiment, an NLP component 306 implemented by interactor 112 is based on a deep learning algorithm. Deep learning is a form of a neural network where nodes are organized into layers. A neural network has a layer of input nodes that accept input data where each of the input nodes are linked to nodes in a next layer. The next layer of nodes after the input layer may be an output layer or a hidden layer. The neural network may have any number of hidden layers that are organized in between the input layer and output layers.

Data propagates through a neural network beginning at a node in the input layer and traversing through synapses to nodes in each of the hidden layers and finally to an output layer. Each synapse passes the data through an activation function such as, but not limited to, a Sigmoid function. Further, each synapse has a weight that is determined by training the neural network. A common method of training a neural network is backpropagation.

Backpropagation is an algorithm used in neural networks to train models by adjusting the weights of the network to minimize the difference between predicted and actual outputs. During training, backpropagation works by propagating the error back through the network, layer by layer, and updating the weights in the opposite direction of the gradient of the loss function. By repeating this process over many iterations, the network gradually learns to produce more accurate outputs for a given input.

Various systems and entities of the software building system 100 may be based on a variation of a neural network or similar machine learning algorithm. For instance, input for NLP systems may be the words that are spoken in a sentence. In one example, each word may be assigned to separate input node where the node is selected based on the word order of the sentence. The words may be assigned various numerical values to represent word meaning whereby the numerical values propagate through the layers of the neural network.

The NLP component 306 employed by the interactor 112 system may output the meaning of words and phrases that are communicated by the user 304. The interactor 112 system may then use the NLP component 306 output to comprehend conversational phrases and sentences to determine the relevant information related to the user's goals of a software project. Further machine learning algorithms may be employed to determine what kind of project the user 304 wants to build including the goals of the user 304 as well as providing relevant options for the user 304.

In various embodiments, the neural network that comprises the NLP component 306 is trained with training data 320 based on previous software application projects. An example, the NLP component 306 is trained to identify features for software applications based on a description of the feature that is given by user 304. For example, a user may describe a communication system for a company where a computer receives communications from employee devices and transmits the communications appropriately to other employee devices where the communications are kept within the company. The NLP component 306 may identify the described functionality as a backend private messaging feature for a software application.

In various embodiments, the NLP component 306 has access to a feature library 322 that includes a multitude of completed components for software applications. The feature library may allow the software building system 100 to quickly include already-completed components in a software application without the need to write them from scratch. The NLP component 306 may be trained to identify components or designs from a feature library and suggest them to the user 304.

The NLP component 306 may include a natural language understanding (NLU) component 324. The NLU component 324 may allow the NLP component 306 to scan various documents and understand them. In one implementation, a user 304 may ask interactor 112 scan a multitude of documents as part of a description for what a software application will do.

In various embodiments, interactor 112 is coupled with spec builder 110 to generate machine-readable specifications or buildcards to develop software applications. In various embodiments, a user 304 may describe various features of a software application to interactor 112 and cause the spec builder 110 to generate a build card. The software building system 100 may determine a cost for the software developer project based on the build card and communicated to the user 304 via interactor 112. Interactor 112 may include a suggestion module 330 that suggests various modifications to the buildcard. In one implementation, the suggestion module 330 makes suggestions based on training data 320 from similar software development projects that have been completed.

In an exemplary embodiment, interactor 112 includes a visual design component 310. The visual design component 310 may be configured to generate one or more visual designs based on conversations that are recorded between interactor 112 and the user 304. The visual design component 310 may include a conversation processor 340 that logs a back-and-forth communication between the user 304 and interactor 112. The visual design component 310 may include a design generator 342 that determines one or more designs based on the log to conversation. In an exemplary embodiment, the design generator 342 generates designs based on training data 320 of conversations and designs from past software developed projects.

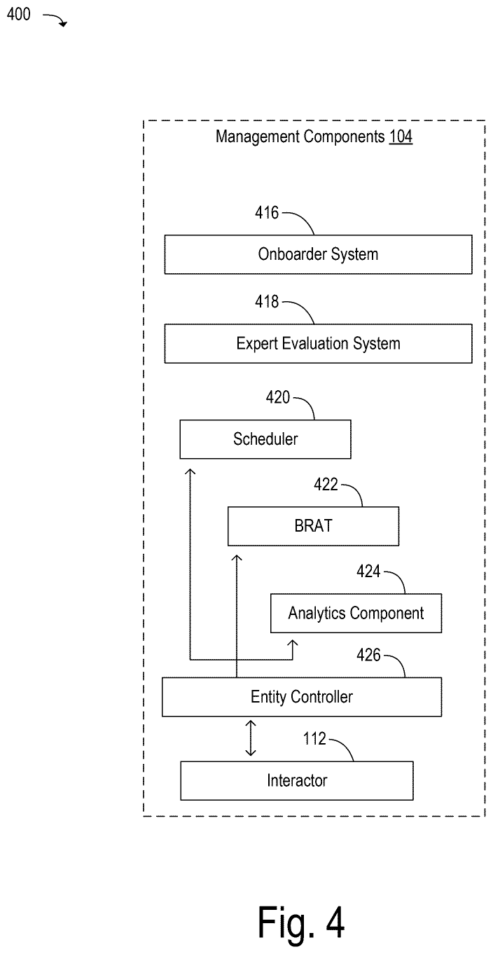

Referring to FIG. 4, FIG. 4 is a schematic 400 illustrating an embodiment of the management components 104 in accordance with a described implementation of the disclosed subject matter. The software building system 100 includes management components 104 that aid the user in managing a complex software building project. The management components 104 allow a user that does not have experience in managing software projects to effectively manage multiple experts in various fields. An embodiment of the management components 104 include the onboarding system 416, an expert evaluation system 418, scheduler 420, BRAT 422, analytics component 424, entity controller 426, and the interactor 112 system.

The onboarding system 416 aggregates experts so they can be utilized to execute specifications that are set up in the software building system 100. In an exemplary embodiment, software development experts may register into the onboarding system 416 which will organize experts according to their skills, experience, and past performance. In one example, the onboarding system 416 provides the following features: partner onboarding, expert onboarding, reviewer assessments, expert availability management, and expert task allocation.

An example of partner onboarding may be pairing a user with one or more partners in a project. The onboarding system 416 may prompt potential partners to complete a profile and may set up contracts between the prospective partners. An example of expert onboarding may be a systematic assessment of prospective experts including receiving a profile from the prospective expert, quizzing the prospective expert on their skill and experience, and facilitating courses for the expert to enroll and complete. An example of reviewer assessments may be for the onboarding system 416 to automatically review completed portions of a project. For instance, the onboarding system 416 may analyze submitted code, validate functionality of submitted code, and assess a status of the code repository. An example of expert availability management in the onboarding system 416 is to manage schedules for expert assignments and oversee expert compensation. An example of expert task allocation is to automatically assign jobs to experts that are onboarded in the onboarding system 416. For instance, the onboarding system 416 may determine a best fit to match onboarded experts with project goals and assign appropriate tasks to the determined experts.

The expert evaluation system 418 continuously evaluates developer experts. In an exemplary embodiment, the expert evaluation system 418 rates experts based on completed tasks and assigns scores to the experts. The scores may provide the experts with valuable critique and provide the onboarding system 416 with metrics with it can use to allocate the experts on future tasks.

Scheduler 420 keeps track of overall progress of a project and provides experts with job start and job completion estimates. In a complex project, some expert developers may be required to wait until parts of a project are completed before their tasks can begin. Thus, effective time allocation can improve expert developer management. Scheduler 420 provides up to date estimates to expert developers for job start and completion windows so they can better manage their own time and position them to complete their job on time with high quality.

The big resource allocation tool (BRAT 422) is capable of generating optimal developer assignments for every available parallel workstream across multiple projects. BRAT 422 system allows expert developers to be efficiently managed to minimize cost and time. In an exemplary embodiment, the BRAT 422 system considers a plethora of information including feature complexity, developer expertise, past developer experience, time zone, and project affinity to make assignments to expert developers. The BRAT 422 system may make use of the expert evaluation system 418 to determine the best experts for various assignments. Further, the expert evaluation system 418 may be leveraged to provide live grading to experts and employ qualitative and quantitative feedback. For instance, experts may be assigned a live score based on the number of jobs completed and the quality of jobs completed.

The analytics component 424 is a dashboard that provides a view of progress in a project. One of many purposes of the analytics component 424 dashboard is to provide a primary form of communication between a user and the project developers. Thus, offline communication, which can be time consuming and stressful, may be reduced. In an exemplary embodiment, the analytics component 424 dashboard may show live progress as a percentage feature along with releases, meetings, account settings, and ticket sections. Through the analytics component 424 dashboard, dependencies may be viewed and resolved by users or developer experts.

The entity controller 426 is a primary hub for entities of the software building system 100. It connects to scheduler 420, the BRAT 422 system, and the analytics component 424 to provide for continuous management of expert developer schedules, expert developer scoring for completed projects, and communication between expert developers and users. Through the entity controller 426, both expert developers and users may assess a project, make adjustments, and immediately communicate any changes to the rest of the development team.

The entity controller 426 may be linked to the interactor 112 system, allowing users to interact with a live project via an intelligent AI conversational system. Further, the interactor 112 system may provide expert developers with up-to-date management communication such as text, email, ticketing, and even voice communications to inform developers of expected progress and/or review of completed assignments.

The management components 104 provide for continuous assessment and management of a project through its entities and systems. The central hub of the management components 104 is entity controller 426. In an exemplary embodiment, core functionality of the entity controller 426 system comprises the following: display computer readable specifications configurations, provide statuses of all computer readable specifications, provide toolkits within each computer readable specification, integration of the entity controller 426 with tracker 646 and the onboarding system 416, integration code repository for repository creation, code infrastructure creation, code management, and expert management, customer management, team management, specification and demonstration call booking and management, and meetings management.

In an exemplary embodiment, the computer readable specification configuration status includes customer information, requirements, and selections. The statuses of all computer readable specifications may be displayed on the entity controller 426, which provides a concise perspective of the status of a software project. Toolkits provided in each computer readable specification allow expert developers and designers to chat, email, host meetings, and implement 3rd party integrations with users. The entity controller 426 allows a user to track progress through a variety of features including but not limited to tracker 646, the UI engine 642, and the onboarding system 416. For instance, the entity controller 426 may display the status of computer readable specifications as displayed in tracker 646. Further, the entity controller 426 may display a list of experts available through the onboarding system 416 at a given time as well as ranking experts for various jobs.

The entity controller 426 may also be configured to create code repositories. For example, the entity controller 426 may be configured to automatically create an infrastructure for code and to create a separate code repository for each branch of the infrastructure. Commits to the repository may also be managed by the entity controller 426.

Entity controller 426 may be integrated into scheduler 420 to determine a timeline for jobs to be completed by developer experts and designers. The BRAT 422 system may be leveraged to score and rank experts for jobs in scheduler 420. A user may interact with the various entity controller 426 features through the analytics component 424 dashboard. Alternatively, a user may interact with the entity controller 426 features via the interactive conversation in the interactor 112 system.

Entity controller 426 may facilitate user management such as scheduling meetings with expert developers and designers, documenting new software such as generating an API, and managing dependencies in a software project. Meetings may be scheduled with individual expert developers, designers, and with whole teams or portions of teams.

Machine learning algorithms may be implemented to automate resource allocation in the entity controller 426. In an exemplary embodiment, assignment of resources to groups may be determined by constrained optimization by minimizing total project cost. In various embodiments a health state of a project may be determined via probabilistic Bayesian reasoning whereby a causal impact of different factors on delays using a Bayesian network are estimated.

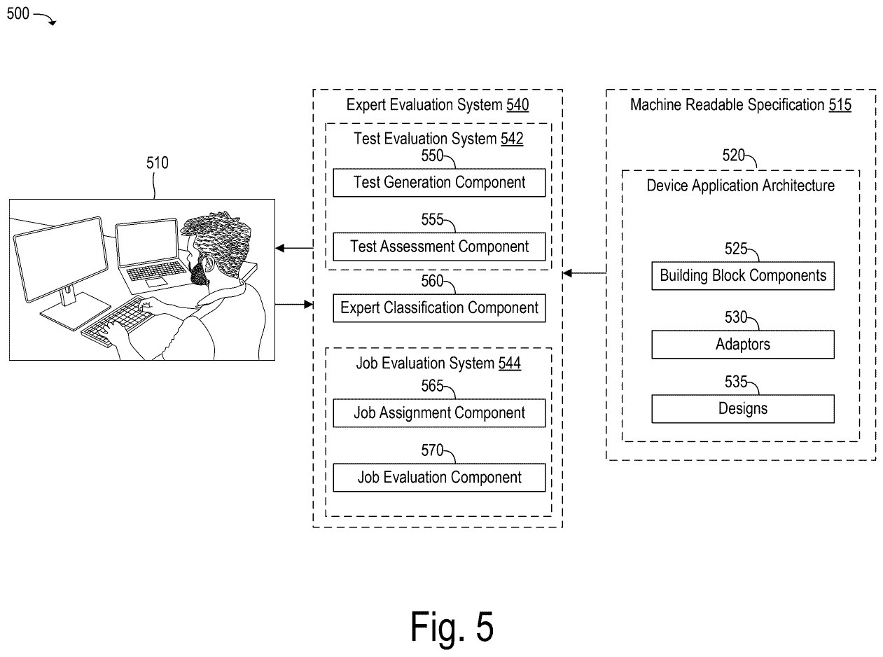

Referring to FIG. 5, FIG. 5 is a schematic 500 illustrating an embodiment of the expert evaluation system 540 in accordance with a described implementation of the disclosed subject matter. The developer 510 may be any individual that contributes to the development of a device application. The developer 510 may be a software developer, a designer, a quality engineer, or the like. The disclosed system may be used to classify one or more developers that are working on a device application. The classification may be used to assess the quality of work that employees are capable of performing. In various embodiments, the classification may be further used to match employees or developers to jobs that they are capable of performing.

In various embodiments, the disclosed subject matter may include a machine readable specification 515 for a device application. The machine-readable specification 515 may include information necessary to define one or more jobs that can be performed by the developer to contribute to the device application. For instance, the machine-readable specification 515 may include details necessary to build a building block component for the device application.

The disclosed system may include an expert evaluation system 540 that is capable of evaluating a developer 510 and evaluating jobs completed by the developer 510. In the exemplary embodiment shown in the schematic 500, the expert evaluation system 540 includes a test evaluation system 542, an expert classification component 560, and a job evaluation system 544.

The test evaluation system 542 may be used to test a developer 510 to determine the developer's 510 ability level. For instance, the test evaluation system 542 may give the developer 510 one or more tests for the developer to complete. Once completed, the test evaluation system 542 may grade the one or more tests to classify the developer 510. The test evaluation system 542 may include a test generation component 550 and a test assessment component 555. The test generation component 550 may be configured to generate one or more tests for the developer 510. In an exemplary embodiment, the test generation component 550 may generate one or more quizzes based on a developer's experience. The developer's experience may be determined based on a resume, an interview with the developer, or the like. An example of a quiz may be a test comprising one or more questions for which there is at least one correct answer. In addition to quizzes, the test generation component 550 may generate one or more assignments for the developer. An example of an assignment may be a task to complete a building block component. Another example of an assignment may be a task to design a user interface for a screen. Another example of a task may be to quality test a device application. An assignment for a developer that is a quality engineer may include conducting an analysis of a device application to identify defects or bugs in the device application. Another assignment for a developer that is a quality engineer may include making one or more improvements to a functionality of a device application or portion of a device application.

The test evaluation system 542 may transmit one or more quizzes or assignments that are generated by the test generation component 550 to the developer 510 for the developer to complete. Once completed, the developer 510 may transmit the completed quiz or assignment back to the test evaluation system 542. The test assessment component 555 may evaluate the completed quiz or assignment to determine a score or rank for the developer 510. For example, the test assessment component 555 may determine whether the developer 510 answered questions in the one or more quizzes correctly. In addition to grading quizzes, the test assessment component 555 may also evaluate assignments that are completed by the developer 510. For example, the test assessment component 555 may evaluate a completed assignment for various criteria to determine a score for the completed assignment. For instance, the test assessment component 555 may use a machine learning algorithm to evaluate a quality of an assignment to develop a software component or device application. An example of a machine learning algorithm is a neural network. In the example given above, the machine learning algorithm may evaluate a structure of the completed assignment to determine whether the structure conforms to standard industry practice. For instance, the machine learning algorithm may evaluate whether the developer 510 adhered to an entity component pattern that was called for in the assignment. The machine learning algorithm may further evaluate output based on various input for the completed assignment. For instance, if the assignment was to develop a component that accepts one or more user logins and sorts them into a database, the machine learning algorithm may test the completed component with one or more user logins to determine whether the completed assignment works properly.

The test assessment component 555 may generate a score that may be used by an expert classification component 560 to determine a classification or rank of the developer 510. The expert classification component 560 may use any combination of quiz scores and assignment scores to determine a classification for the developer 510. In various embodiments, the expert classification component 560 may weight one or more quizzes or assignments based on various criteria. For instance, the expert classification component 560 may weight a quiz that is related to a developers 510 expertise more than other quizzes or assignments. In another example, the expert classification component 560 may weight one or more quizzes or one or more assignments based on jobs that are available from the machine-readable specification 515. For instance, the expert classification component 560 may weight quizzes or assignments related to databases if there are pending jobs that require database work. A pending job may be a job that is yet to be completed. The term “pending machine readable specification”, as used herein, is a machine readable specification that includes one or more pending jobs.

The job evaluation system 544 transmits jobs to the developer 510 and assesses completed jobs that are received from the developer 510. In an exemplary embodiment, the job evaluation system 544 may include a job assignment component 565 and a job evaluation component 570. The job assignment component 565 may accept one or more jobs based on a machine-readable specification 515. In an exemplary embodiment, the machine-readable specification 515 may include one or more building block components 525, one or more adapters 530 that are designed to link the building block components 525, and one or more designs 535 for a device application. Additionally, the machine-readable specification 515 may include a device application architecture 520 that defines a structure for the building block components 525, the adapters 530, and designs 535.

One or more jobs may be resolved from the machine-readable specification 515. The jobs may be then passed by the job assessment component 565 to a developer 510 to be completed. Once completed, the developer 510 may transmit the completed job back to the job evaluation system 544. The job evaluation component 570 may assess the quality of the completed job. In an exemplary embodiment, the job evaluation component 570 comprises a machine learning algorithm that is configured to evaluate completed jobs. In various embodiments, different machine learning algorithms or models may be configured based on a type of job. For example, a machine learning algorithm may be configured to evaluate completed user interface components for device applications. For instance, a job to develop a building block component 525 that allows a user to select one or more items for purchase on a device application may be assigned to a developer 510. Once the job is completed, the job evaluation component 570 may evaluate the completed job using a machine learned algorithm that is trained to evaluate components related to user input.

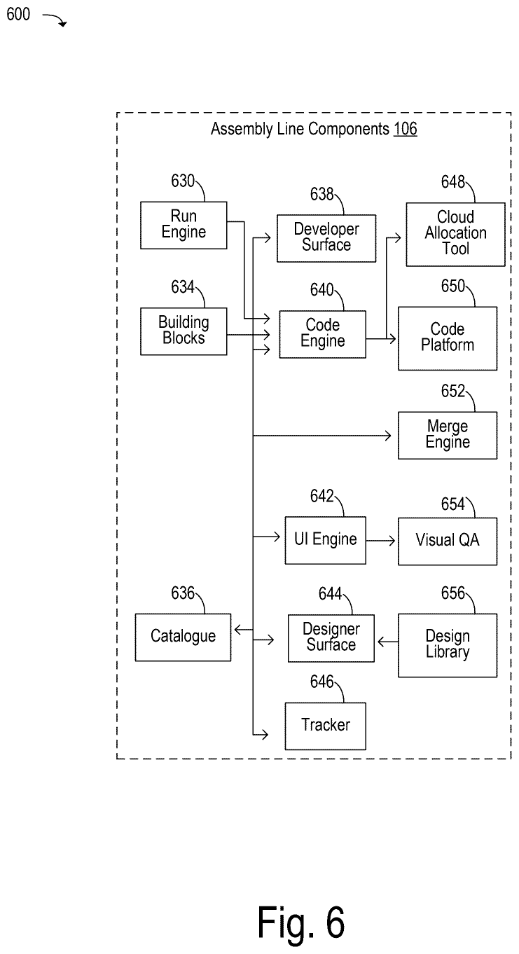

Referring to FIG. 6, FIG. 6 is a schematic 600 illustrating an embodiment of an assembly line and surfaces of the disclosed subject matter. The assembly line components 106 comprise underlying components that provide the functionality to the software building system 100. The embodiment of the assembly line components 106 includes a run engine 630, building block components 634, catalogue 636, developer surface 638, a code engine 640, a UI engine 642, a designer surface 644, tracker 646, a cloud allocation tool 648, a code platform 650, a merge engine 652, visual QA 654, and a design library 656.

The run engine 630 may maintain communication between various building block components within a project as well as outside of the project. In an exemplary embodiment, the run engine 630 may send HTTP/S GET or POST requests from one page to another.

The building block components 634 are reusable code that are used across multiple computer readable specifications. The term buildcards, as used herein, refer to machine readable specifications that are generated by specification builder 110, which may convert user specifications into a computer readable specification that contains the user specifications and a format that can be implemented by an automated process with minimal intervention by expert developers.

The computer readable specifications are constructed with building block components 634, which are reusable code components. The building block components 634 may be pretested code components that are modular and safe to use. In an exemplary embodiment, every building block component 634 consists of two sections-core and custom. Core sections comprise the lines of code which represent the main functionality and reusable components across computer readable specifications. The custom sections comprise the snippets of code that define customizations specific to the computer readable specification. This could include placeholder texts, theme, color, font, error messages, branding information, etc.

Catalogue 636 is a management tool that may be used as a backbone for applications of the software building system 100. In an exemplary embodiment, the catalogue 636 may be linked to the entity controller 426 and provide it with centralized, uniform communication between different services.

Developer surface 638 is a virtual desktop with preinstalled tools for development. Expert developers may connect to developer surface 638 to complete assigned tasks. In an exemplary embodiment, expert developers may connect to developer surface from any device connected to a network that can access the software project. For instance, developer experts may access developer surface 638 from a web browser on any device. Thus, the developer experts may essentially work from anywhere across geographic constraints. In various embodiments, the developer surface uses facial recognition to authenticate the developer expert at all times. In an example of use, all code that is typed by the developer expert is tagged with an authentication that is verified at the time each keystroke is made. Accordingly, if code is copied, the source of the copied code may be quickly determined. The developer surface 638 further provides a secure environment for developer experts to complete their assigned tasks.

The code engine 640 is a portion of a code platform 650 that assembles all the building block components required by the build card based on the features associated with the build card. The code platform 650 uses language-specific translators (LSTs) to generate code that follows a repeatable template. In various embodiments, the LSTs are pretested to be deployable and human understandable. The LSTs are configured to accept markers that identify the customization portion of a project. Changes may be automatically injected into the portions identified by the markers. Thus, a user may implement custom features while retaining product stability and reusability. In an example of use, new or updated features may be rolled out into an existing assembled project by adding the new or updated features to the marked portions of the LSTs.

In an exemplary embodiment, the LSTs are stateless and work in a scalable Kubernetes Job architecture which allows for limitless scaling that provide the needed throughput based on the volume of builds coming in through a queue system. This stateless architecture may also enable support for multiple languages in a plug & play manner.

The cloud allocation tool 648 manages cloud computing that is associated with computer readable specifications. For example, the cloud allocation tool 648 assesses computer readable specifications to predict a cost and resources to complete them. The cloud allocation tool 648 then creates cloud accounts based on the prediction and facilitates payments over the lifecycle of the computer readable specification.

The merge engine 652 is a tool that is responsible for automatically merging the design code with the functional code. The merge engine 652 consolidates styles and assets in one place allowing experts to easily customize and consume the generated code. The merge engine 652 may handle navigations that connect different screens within an application. It may also handle animations and any other interactions within a page.

The UI engine 642 is a design-to-code product that converts designs into browser ready code. In an exemplary embodiment, the UI engine 642 converts designs such as those made in Sketch into React code. The UI engine may be configured to scale generated UI code to various screen sizes without requiring modifications by developers. In an example of use, a design file may be uploaded by a developer expert to designer surface 644 whereby the UI engine automatically converts the design file into a browser ready format.

Visual QA 654 automates the process of comparing design files with actual generated screens and identifies visual differences between the two. Thus, screens generated by the UI engine 642 may be automatically validated by the visual QA 654 system. In various embodiments, a pixel to pixel comparison is performed using computer vision to identify discrepancies on the static page layout of the screen based on location, color contrast and geometrical diagnosis of elements on the screen. Differences may be logged as bugs by scheduler 420 so they can be reviewed by expert developers.

In an exemplary embodiment, visual QA 654 implements an optical character recognition (OCR) engine to detect and diagnose text position and spacing. Additional routines are then used to remove text elements before applying pixel-based diagnostics. At this latter stage, an approach based on similarity indices for computer vision is employed to check element position, detect missing/spurious objects in the UI and identify incorrect colors. Routines for content masking are also implemented to reduce the number of false positives associated with the presence of dynamic content in the UI such as dynamically changing text and/or images.

The visual QA 654 system may be used for computer vision, detecting discrepancies between developed screens, and designs using structural similarity indices. It may also be used for excluding dynamic content based on masking and removing text based on optical character recognition whereby text is removed before running pixel-based diagnostics to reduce the structural complexity of the input images.

The designer surface 644 connects designers to a project network to view all of their assigned tasks as well as create or submit customer designs. In various embodiments, computer readable specifications include prompts to insert designs. Based on the computer readable specification, the designer surface 644 informs designers of designs that are expected of them and provides for easy submission of designs to the computer readable specification. Submitted designs may be immediately available for further customization by expert developers that are connected to a project network.

Similar to building block components 634, the design library 656 contains design components that may be reused across multiple computer readable specifications. The design components in the design library 656 may be configured to be inserted into computer readable specifications, which allows designers and expert developers to easily edit them as a starting point for new designs. The design library 656 may be linked to the designer surface 644, thus allowing designers to quickly browse pretested designs for user and/or editing.

Tracker 646 is a task management tool for tracking and managing granular tasks performed by experts in a project network. In an example of use, common tasks are injected into tracker 646 at the beginning of a project. In various embodiments, the common tasks are determined based on prior projects, completed, and tracked in the software building system 100.

The assembly line components 106 support the various features of the management components 104. For instance, the code platform 650 is configured to facilitate user management of a software project. The code engine 640 allows users to manage the creation of software by standardizing all code with pretested building block components. The building block components contain LSTs that identify the customizable portions of the building block components 634.

The machine readable specifications may be generated from user specifications. Like the building block components, the computer readable specifications are designed to be managed by a user without software management experience. The computer readable specifications specify project goals that may be implemented automatically. For instance, the computer readable specifications may specify one or more goals that require expert developers. The scheduler 420 may allocate the expert developers based on the computer readable specifications or with direction from the user. Similarly, one or more designers may be hired based on specifications in a computer readable specification. Users may actively participate in management or take a passive role.

A cloud allocation tool 648 is used to determine costs for each computer readable specification. In an exemplary embodiment, a machine learning algorithm is used to assess computer readable specifications to estimate costs of development and design that is specified in a computer readable specification. Cost data from past projects may be used to train one or more models to predict costs of a project.

The developer surface 638 system provides an easy to set up platform within which expert developers can work on a software project. For instance, a developer in any geography may connect to a project via the cloud system 862 and immediately access tools to generate code. In one example, the expert developer is provided with a preconfigured IDE as they sign into a project from a web browser.

The designer surface 644 provides a centralized platform for designers to view their assignments and submit designs. Design assignments may be specified in computer readable specifications. Thus, designers may be hired and provided with instructions to complete a design by an automated system that reads a computer readable specification and hires out designers based on the specifications in the computer readable specification. Designers may have access to pretested design components from a design library 656. The design components, like building block components, allow the designers to start a design from a standardized design that is already functional.

The UI engine 642 may automatically convert designs into web ready code such as React code that may be viewed by a web browser. To ensure that the conversion process is accurate, the visual QA 654 system may evaluate screens generated by the UI engine 642 by comparing them with the designs that the screens are based on. In an exemplary embodiment, the visual QA 654 system does a pixel to pixel comparison and logs any discrepancies to be evaluated by an expert developer.

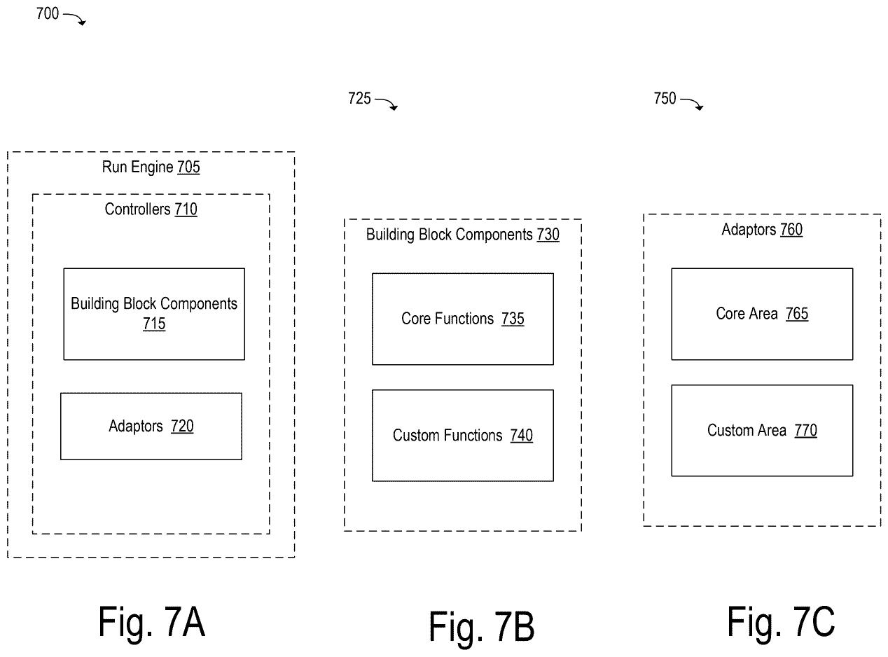

Referring to FIG. 7A, FIG. 7A is a schematic 700 for an embodiment of a run engine 705 of the disclosed subject matter. The run engine 705 facilitates the transmission of messages within the software application. Building block components 715 that make up core features of a software application are operated by the run engine 705. In various embodiments, a developer may select a multitude of building block components 715 depending on features that are desired for the software application. The run engine 705 may contain any number of building block components 715 to implement any number of features.

In an exemplary embodiment, the run engine 705 comprises one or more controllers 710. Each controller 710 may comprise one or more building block components 715 and one or more adapters 720. The controller 710 may include logic that determines an interaction between building block components 715. For instance, a controller 710 may comprise a building block component 715 that includes the functions for logging a user into a server. Logic in the controller 710 may determine when those functions are implemented. Logic in the controller may also help determine one or more functions that are implemented after the login is implemented.

The building block components 715 are software modules that comprise one or more functions for implementing features in a software application. Each building block component 715 in the controller 710 may operate independently of each other building block component 715 in the controller 710. Accordingly, removing or adding one or more building block components 715 from the controller 710 or from the software application does not impact a functionality of the other building block components 715 in the software application or controller 710. Building block components 715 may be developed in any order or in parallel in a software application. For instance, multiple developers may concurrently develop one or more building block components 715 for the same software application.

The controller 710 may include one or more adapters 720 that enable the sending and receiving of messages to and from building block components 715. Building block components 715 may communicate with other building block components 715 via the sending of messages. Adapters 720 may be used to generate messages based on output from a building block component 715. Adapters 720 may also be used to receive messages for one or more building block components 715. A single adapter 720 may be implemented to send and receive messages for one or more building block components 715.

In an example of use, when a building block component 715, which is configured to log a user into an application, completes a login, an adapter 720 may be configured to broadcast a message that a login is complete. Another building block component 715, which is configured to open a startup screen may be activated based on the login complete message. Accordingly, an adapter may receive the login complete message and activate a building block component 715 to open the start of screen.

Referring to FIG. 7B, FIG. 7B is a schematic 725 for an embodiment of a building block component 730 that may be implemented in the disclosed subject matter. A software application may include one or more building block components 730. Each building block component 730 operates independently of the other building block components 730, but may be configured to send and receive messages to and from the other building block components 730.

Each building block component 730 comprises software functions that enable one or more features in the software application. For instance, a building block component 730 for implementing a clickable button may include one or more functions, that when executed, implement a clickable button utility. Each building block component 730 may comprise one or more core functions 735 and one or more custom functions 740. The core functions 735 may be configured to be un-editable in a building block component 730. A developer may be encouraged to include one or more custom functions 740 in a building block component 730 to implement functionality or features that are specific to their software application.

Each of the core functions 735 and custom functions 740 may be configured so as not to depend on functionality from other building block components 730. Thus, each of the building block components 730 may be developed independently. This may allow for rapid development as building block components 730 may be developed concurrently by multiple developers. Further, building block components 730 may be configured to implement specific features in an application that are common to multiple applications.

Thus, a single building block component 730 may be developed to be used as a utility. A developer may choose to include a preconfigured building block component 730 based on features that the developer desires in the software application. A completed software application may be further developed by adding additional building block components 730 because the additional building block components 730 do not depend on any of the existing building block components 730. Further, adding additional building blocks to a software application will not break any of the functionality of the software application.

Referring to FIG. 7C, FIG. 7C is a schematic 750 for an embodiment of an adapter 760 that may be implemented in the disclosed subject matter. Building block components 730 may be configured not to depend on any functions of other building block components 730. However, a building block component may be configured to receive messages that are generated by another building block component 730. The transmission of messages from one building block component 730 to another is facilitated by the adapters 760.

Adapters 760 allow for building block components 730 to be interconnected without being interdependent on functionality. A building block component 730 may generate a message that is to be received by another building block component 730. An adapter 760 may be configured to broadcast a message from one building block component 730 and another adapter 760 may be configured to listen for the message. For example, the adapter 760 may be configured to subscribe to one or more messages, where subscribing puts the adapter in a state that causes the adapter 760 to perform an action when it receives the message. The terms listening and subscribing, as used herein, are used interchangeably as they apply to the adapters 760.

In various embodiments, an adapter may be configured to broadcast data that is nested in a message. For instance, an adapter may broadcast a message to open a checkout screen for a shopping application. The message to open the checkout screen may be received by an adapter 760 that executes one or more functions on a building block component 634 that operates the checkout screen. The message may further include nested data such as one or more shopping items that the user selected. The nested data may be received by the adapter 760 along with the message to be transmitted to the building block component 730 that implements the checkout screen.

Like building block components 730, the adapters 760 may each include a core area 765 and a custom area 770. The core area 765 may include one or more functions that facilitate sending and receiving messages with the adapter 760. In various embodiments, an adapter may have a listen function whereby any adapter may be configured to listen for one or more messages that may be transmitted within the run engine 705. In an example of use, an adapter 760 is configured to listen for a “LOGIN_COMPLETE” message. When the adapter 760 receives the “LOGIN_COMPLETE” message, it executes one or more functions in a building block component 730.

The custom area 770 in each adapter 760 may be utilized to implement logic in a software application. For example, the custom area may be edited to execute one or more functions of a building block upon receiving a message from the run engine 705. In another example, logic may be implemented to broadcast one or more messages responsive to execution of functions in a building block component 730.

In various embodiments, the customer logic area may be configurable by a machine readable specification. For example, a machine readable specification may specify that execution of a function by a first building block component triggers execution of a function by a second building block component. Accordingly, a computer system may automatically insert logic into a first adapter that causes the adapter to transmit a message responsive to the first building block component executing the function. The machine readable specification may further insert logic into a second adapter that causes the second adapter to listen for the message and cause the second building block component to execute a function responsive to receiving the message.

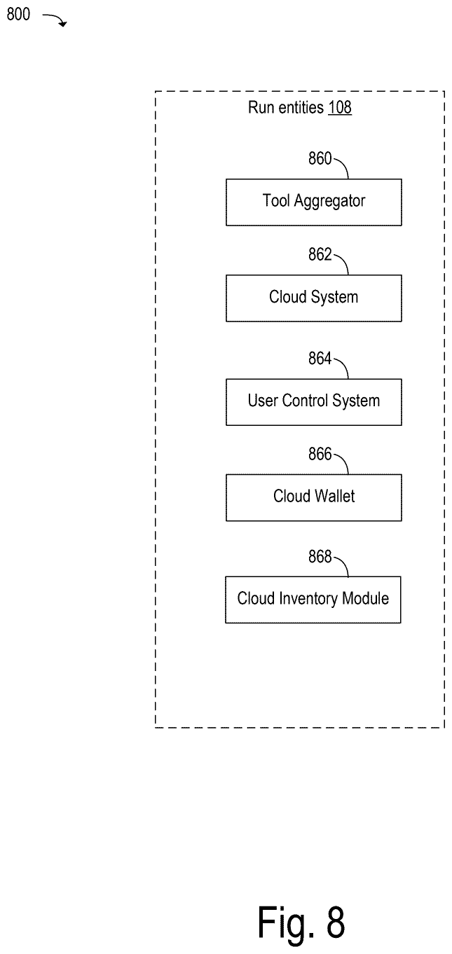

Referring to FIG. 8, FIG. 8 is a schematic 800 illustrating an embodiment of the run entities 108 of the disclosed subject matter. The run entities 108 contain entities that all users, partners, expert developers, and designers use to interact within a centralized project network. In an exemplary embodiment, the run entities 108 include tool aggregator 860, cloud system 862, user control system 864, cloud wallet 866, and a cloud inventory module 868. The tool aggregator 860 entity brings together all third-party tools and services required by users to build, run and scale their software project. For instance, it may aggregate software services from payment gateways and licenses such as Office 365. User accounts may be automatically provisioned for needed services without the hassle of integrating them one at a time. In an exemplary embodiment, users of the run entities 108 may choose from various services on demand to be integrated into their application. The run entities 108 may also automatically handle invoicing of the services for the user.

The cloud system 862 is a cloud platform that is capable of running any of the services in a software project. The cloud system 862 may connect any of the entities of the software building system 100 such as the code platform 650, developer surface 638, designer surface 644, catalogue 636, entity controller 426, spec builder 110, the interactor 112 system, and the prototype module 114 to users, expert developers, and designers via a cloud network. In one example, cloud system 862 may connect developer experts to an IDE and design software for designers allowing them to work on a software project from any device.

The user control system 864 is a system requiring the user to have input over every feature of a final product in a software product. With the user control system 864, automation is configured to allow the user to edit and modify any features that are attached to a software project regardless as to the coding and design by developer experts and designer. For example, building block components 634 are configured to be malleable such that any customizations by expert developers can be undone without breaking the rest of a project. Thus, dependencies are configured so that no one feature locks out or restricts development of other features.

Cloud wallet 866 is a feature that handles transactions between various individuals and/or groups that work on a software project. For instance, payment for work performed by developer experts or designers from a user is facilitated by cloud wallet 866. A user need only set up a single account in cloud wallet 866 whereby cloud wallet handles payments of all transactions.

A cloud allocation tool 648 may automatically predict cloud costs that would be incurred by a computer readable specification. This is achieved by consuming data from multiple cloud providers and converting it to domain specific language, which allows the cloud allocation tool 648 to predict infrastructure blueprints for customers' computer readable specifications in a cloud agnostic manner. It manages the infrastructure for the entire lifecycle of the computer readable specification (from development to after care) which includes creation of cloud accounts, in predicted cloud providers, along with setting up CI/CD to facilitate automated deployments.

The cloud inventory module 868 handles storage of assets on the run entities 108. For instance, building block components 634 and assets of the design library are stored in the cloud inventory entity. Expert developers and designers that are onboarded by onboarding system 416 may have profiles stored in the cloud inventory module 868. Further, the cloud inventory module 868 may store funds that are managed by the cloud wallet 866. The cloud inventory module 868 may store various software packages that are used by users, expert developers, and designers to produce a software product.

The run entities 108 provides a user with 3^{rd} party tools and services, inventory management, and cloud services in a scalable system that can be automated to manage a software project. In an exemplary embodiment, the run entities 108 is a cloud-based system that provides a user with all tools necessary to run a project in a cloud environment.

For instance, the tool aggregator 860 automatically subscribes with appropriate 3^{rd} party tools and services and makes them available to a user without a time consuming and potentially confusing set up. The cloud system 862 connects a user to any of the features and services of the software project through a remote terminal. Through the cloud system 862, a user may use the user control system 864 to manage all aspects of a software project including conversing with an intelligent AI in the interactor 112 system, providing user specifications that are converted into computer readable specifications, providing user designs, viewing code, editing code, editing designs, interacting with expert developers and designers, interacting with partners, managing costs, and paying contractors.

A user may handle all costs and payments of a software project through cloud wallet 866. Payments to contractors such as expert developers and designers may be handled through one or more accounts in cloud wallet 866. The automated systems that assess completion of projects such as tracker 646 may automatically determine when jobs are completed and initiate appropriate payment as a result. Thus, accounting through cloud wallet 866 may be at least partially automated. In an exemplary embodiment, payments through cloud wallet 866 are completed by a machine learning AI that assesses job completion and total payment for contractors and/or employees in a software project.

Cloud inventory module 868 automatically manages inventory and purchases without human involvement. For example, cloud inventory module 868 manages storage of data in a repository or data warehouse. In an exemplary embodiment, it uses a modified version of the knapsack algorithm to recommend commitments to data that it stores in the data warehouse. Cloud inventory module 868 further automates and manages cloud reservations such as the tools providing in the tool aggregator 860.

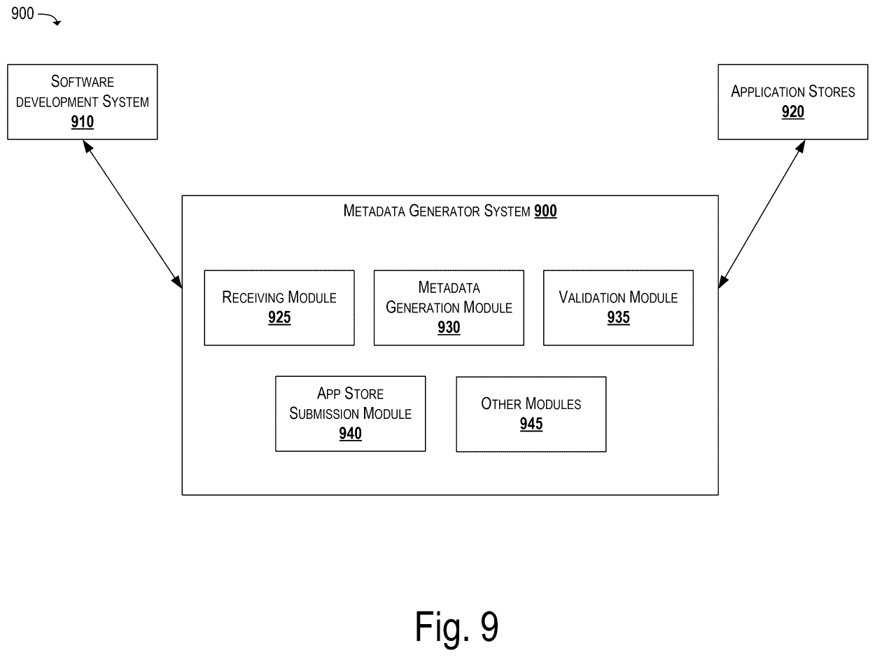

Referring to FIG. 9, FIG. 9 is a schematic diagram of a metadata generator system 900 in an embodiment of the disclosed subject matter. In some exemplary embodiments, the metadata generator system 900 is configured to enable the automatic submission of the software application to various application stores. In some embodiments, the metadata generator system 900 is coupled to a software development system 910, and one or more application stores 920.

In some embodiments, the metadata generator system 900 is configured to receive the software application from the software development system 910, generate metadata (which will be discussed later), and provide the metadata for submitting the software application to one or more application stores 920. The one or more application stores 920 may be a specific application store from which an end-user may download the software application. For example, the one or more application stores may be Apple App Store, Google Play Store, Amazon App Store, Galaxy Store, and so on. In some other embodiments, the metadata generator system 900 may be part of the software development system 910. In some embodiments, the metadata generator system 900 is configured to generate the metadata when the software application is developed. In some other embodiments, the metadata generator system 900 is configured to generate the metadata when the software application is ongoing or initiated.

In some embodiments, the metadata generator system 900 may be configured as a standalone system. The metadata generator system 900 comprises one or more components coupled with each other that may be deployed on a single system or different systems. In some embodiments, the metadata generator system 900 comprises a receiving module 925, a metadata generator module 930, a validation module 935, an app store submission module 940, and other modules 945. Each of the receiving module 925, the metadata generator module 930, the validation module 935, and the app store submission module 940 is configured to perform a specific function to submit the software application to the one or more application stores 920 automatically.

In some embodiments, the other modules 945 may be used to perform various miscellaneous functionalities of the metadata generator system 900. It will be appreciated that such modules 945 may be represented as a single module or a combination of different modules.

The metadata generator system 900 comprises the receiving module 925, which is configured to receive one or more inputs from the software development system 910. In some embodiments, the receiving module 925 is also configured to receive the one or more inputs from the software development system 910 to publish the software application to the one or more application stores 920. In some embodiments, the receiving module 925 is configured to receive the one or more inputs from a user (such as a developer or a client) associated with the software development system 910. In some embodiments, the one or more inputs are received when the user clicks on an icon to publish the software application to the one or more application stores 920. The icon is displayed on the user interface associated with the user in the software development system 910. In some embodiments, the one or more inputs are received when the user manually enters the one or more inputs on a user interface associated with the metadata generator system 900.

In some embodiments, the one or more inputs comprise at least one of: software application details (such as a software application ID and a software application name) and user credentials for the software application. In some other embodiments, the one or more inputs comprise buildcard information of the software application. In some other embodiments, the receiving module 925 is configured to retrieve the buildcard information based on the one or more inputs from the user. In some embodiments, in order to retrieve the buildcard information, the receiving module 925 may access a database or repository storing buildcards related to various software applications.

The metadata generator system 900 comprises the metadata generator module 930 which is coupled to the receiving module 925. In some embodiments, the metadata generator module 930 is initially configured to determine requirements of the one or more application stores 920, needed for the software application to submit to the one or more application stores 920. In some embodiments, in order to determine the requirements, the metadata generator module 930 is configured to connect to the one or more application stores 920, through Application Program Interfaces (APIs). In some embodiments, the metadata generator module 930 is configured to connect to at least one of the one or more application stores 920 based on one or more instructions from the user. The one or more instructions may be retrieved by accessing the software development system 910 using the user credentials received from the receiving module 925. For example, when one or more instructions specify that the software application is an Android application, the metadata generator module 930 may connect to the Google Play Store to retrieve the requirements to submit the software application to the Google Play Store. In some embodiments, the requirements comprise at least one of: a software application description, keywords that define the software application, screenshots of the software application, an application icon for the software application to be used, title of the software application, and a privacy policy information of the software application.

In some embodiments, the metadata generator module 930 is configured to connect to at least one of the one or more application stores 920 based on analysis of source code of the software application. The source code may be accessed using the user credentials received from the receiving module 925. For example, when the metadata generator module 930 may identify that the software application is only an Android application based on the analysis of the source code, the metadata generator module 930 may connect to the Google Play Store to retrieve the requirements to submit the software application to the Google Play Store.

Upon retrieving the requirements, the metadata generator module 930 is configured to analyze one or more attributes of the software application. In some embodiments, the metadata generator module 930 may employ one or more large language models (LLMs) to analyze the one or more attributes of the software application. The one or more attributes may comprise at least one of: initial inputs provided by the client to develop the software application, one or more documents (such as a business requirement document of the software application) provided by the client, client feedback during the software application development process, source codes related to the software application, the buildcard information, and any other details related to the software application.

Based on the analysis of the one or more attributes, the metadata generator module 930 is configured to determine functions and properties of the software application. In some embodiments, the functions specify the tasks or operations that may be performed by the software application. For example, the functions of the software application can be user authentication, data processing, report generation, communication, payment processing, and file management. In some embodiments, the properties describe one or more characteristics of the software application. For example, the properties of the software application may be user interface design of the software application, performance of the software application, scalability of the software application, compatibility of the software application, security of the software application and reliability of the software application.

Further, in some embodiments, the metadata generator module 930 is configured to determine the functions and properties of the software application based on the buildcard information.

Upon determining the functions and properties of the software application, the metadata generator module 930 is configured to generate metadata for the software application using the determined requirements. In some embodiments, the metadata may comprise consolidated information that is defined in the requirements. In some embodiments, the metadata generator module 930 is configured to generate the metadata that comprises the application icon for the software application using the determined functions and properties. In some embodiments, in order to generate the application icon, the metadata generator module 930 may employ one or more large multimodal models (LMMs). For example, the LMMs may be GPT, DALL-E, MidJourney, Adobe Firefly, and so on. Further, in some embodiments, the metadata generator module 930 is configured to generate the metadata that comprises the screenshots of the software application using the determined functions and properties.

Further, in some embodiments, the determine one or more third-party applications utilized by the software application based on the determined functions and properties. For example, the software application may utilize the third-party application (such as a payment gateway application) to enable the payment transaction in the software application, the metadata generator module 930 is configured to determine such third-party applications. Upon determining the third-party applications, the metadata generator module 930 may generate the metadata for the software application.

The metadata generator system 900 comprises the validation module 935, which is coupled to metadata generator module 930. In some embodiments, the validation module 935 is configured to validate the generated metadata against submission requirements of the one or more application stores 920 before submitting the software application to the one or more application stores 920. In some embodiments, the validation module 935 may employ natural language processing (NLP) models to validate the generated metadata.

In some embodiments, the validation module 935 is configured to validate that comprises verifying whether the generated metadata is in compliance with the submission requirements. In some embodiments, the submission requirements may specify format specifications, content guidelines, and any other criteria specified by the application stores for the metadata to be submitted for the one or more application stores 920. For example, the format specifications may specify image dimensions, file size, file format, and character limit of the metadata. Similarly, content guidelines may specify the language to be used and privacy policy information. In some embodiments, the metadata generator module 930 is configured to modify the generated metadata when the generated metadata is not in compliance with the submission requirements.

The metadata generator system 900 comprises the app store submission module 940, which is coupled to the metadata generator module 930 and the validation module 935. In some embodiments, the app store submission module 940 is configured to submit the software application to the one or more application stores 920 using the generated metadata. In some embodiments, the app store submission module 940 is configured to automatically create a developer account associated with the one or more application stores 940. Upon creating the developer account, the app store submission module 940 is configured to submit the software application using the generated metadata and using the created developer account. Further, in some embodiments, the app store submission module 940 is configured to automatically fill submission forms using the generated metadata for submitting the software application to the one or more application stores 940.

Thus, the metadata generator system 900 is configured to reduce manual effort and minimize errors in the metadata generation and submission. Further, by automating the metadata generation and submission, developers can save significant time and resources, allowing them to focus more on the core aspects of software development.

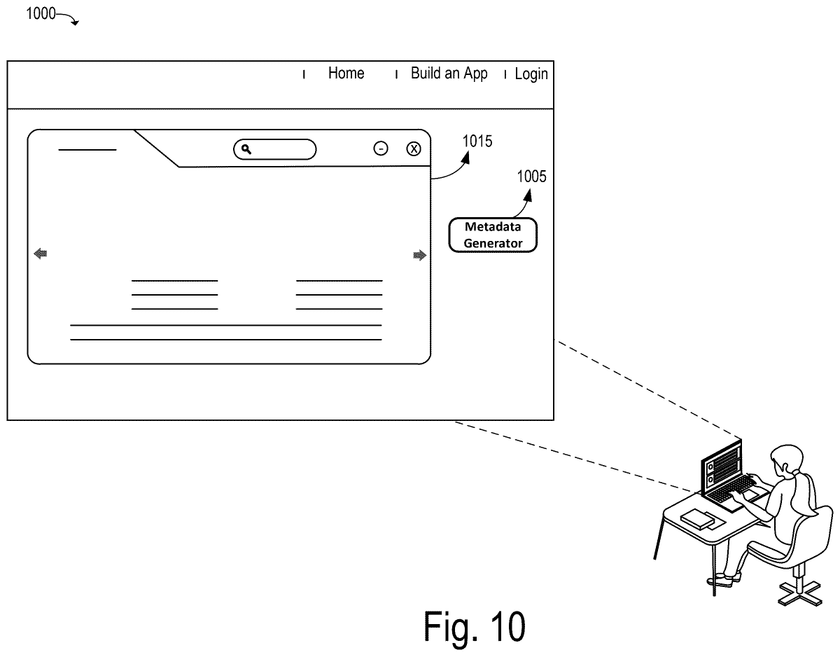

Referring to FIG. 10, FIG. 10 is an example user interface associated with a user device to develop the software application.

In one embodiment, the user interface may be provided when the user accesses a software development application provided by the software development system 910. The user may access the software development application either through a web browser or an application provided by the software development system 910. As shown in FIG. 10, the user interface 1000 comprises a metadata generator icon 1005, which is utilized by the client or the developer to streamline the process of publishing software applications to various the one or more application stores 920.

The developer, when developing the software application, may access developer interface 1015 and may start typing source code for developing the software application or modify the existing source code. The developer interface 1015 is a console where the developer develops the source code of the software application. While the developer is developing the software application or once the software application is developed, the developer can initiate the auto submission of the software application to the one or more application stores 920 using the metadata generator icon 1005. By clicking on the metadata generator icon 1005, the user device may initiate identifying requirements of each of the one or more application stores 920. The requirements may specify what details are required for the submission of the software application to the corresponding application store. Further, the user device may generate the metadata based on the identified requirements of each of the one or more application stores. In some embodiments, the user device may perform similar functionalities as that of the metadata generator system 900 to generate the metadata and to enable the auto-submission of the metadata to the one or more application stores 920.

In some embodiments, the generated metadata comprises at least one of a software application description, keywords that define the software application, screenshots of the software application, an application icon for the software application to be used, title of the software application, and a privacy policy information of the software application. Further, in some embodiments, the user device may employ large language models (LLMs) to generate the metadata. Further, in some embodiments, the generated metadata may be refined as per the submission requirements of the one or more application stores 920.

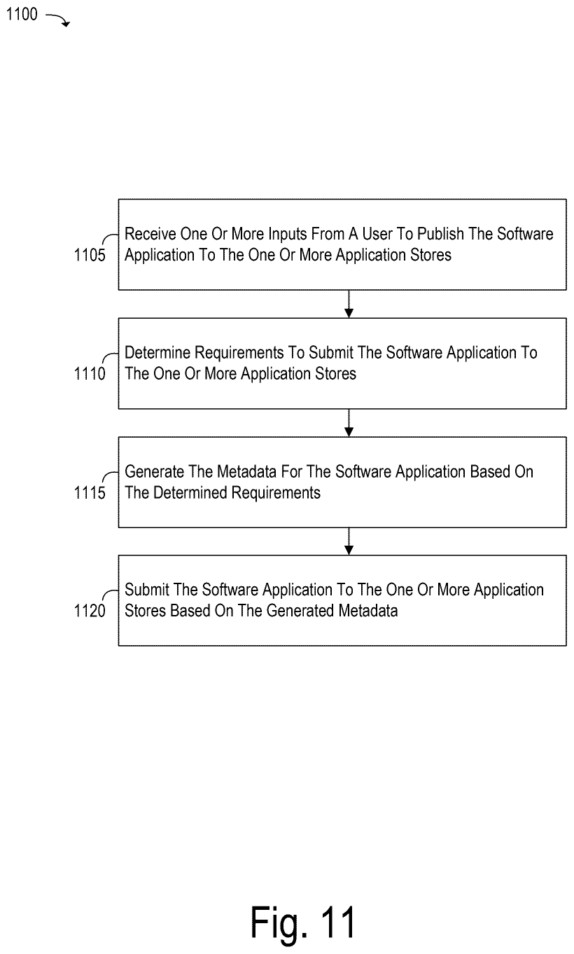

Referring to FIG. 11, FIG. 11 is a flow diagram for an embodiment of the disclosed subject matter for a process 1100 of submitting a software application to one or more application stores.

At step 1105, the process 1100 may receive one or more inputs from a user. In some embodiments, the one or more inputs are received from the user by the receiving module 925. In some embodiments, the one or more inputs are received by the receiving module 925 when the user clicks on an icon to publish the software application to the one or more application stores 920. In some embodiments, the one or more inputs are received by the receiving module 925 when the user manually enters the one or more inputs on a user interface associated with the metadata generator system 900. The one or more inputs may include at least one of: software application details (such as a software application ID and a software application name) and user credentials for the software application.

At step 1110, the process 1100 may determine requirements to submit the software application to the one or more application stores. In some embodiments, the requirements to submit the software application to one or more application stores are determined by the metadata generator module 930. In some embodiments, in order to determine the requirements, the metadata generator module 930 connects to the one or more application stores 920, through Application Program Interfaces (APIs). In some embodiments, the requirements determined by the metadata generator module 930 may comprise at least one of: a software application description, keywords that define the software application, screenshots of the software application, an application icon for the software application to be used, title of the software application, and a privacy policy information of the software application.

At step 1115, the process 1100 may generate metadata for the software application based on the determined requirements. In some embodiments, the metadata for the software application is generated by the metadata generator module 930 based on the determined requirements. In order to generate the metadata, initially one or more attributes of the software application are analyzed by the metadata generator module 930. Further, based on the analysis of the one or more attributes, functions and properties of the software application are determined by the metadata generator module 930. Upon determining the functions and properties of the software application, the metadata for the software application is generated by the metadata generator module 930 using the determined requirements.

At step 1120, the process 1100 may submit the software application to the one or more application stores based on the generated metadata. In some embodiments, the software application is submitted to the one or more application stores 920 by the app store submission module 940 based on the generated metadata. In some embodiments, in order to submit the software application, a developer account associated with the one or more application stores 920 is created by the app store submission module 940. Upon creating the developer account, the software application is submitted to the one or more application stores 920 using the generated metadata and the created developer account.

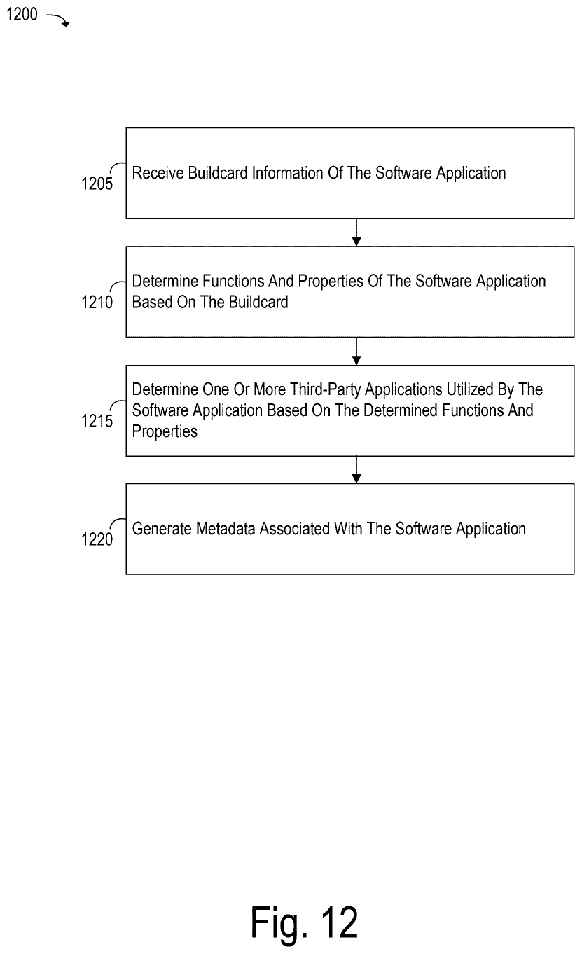

Referring to FIG. 12, FIG. 12 is a flow diagram for an embodiment of the disclosed subject matter for a process 1200 of generating metadata for a software application to one or more application stores.

At step 1205, the process 1200 may receive buildcard information of the software application. In some embodiments, the buildcard information is received by the receiving module 925.

At step 1210, the process 1200 may determine functions and properties of the software application based on the buildcard information. In some embodiments, the functions and the properties of the software application are determined by the metadata generator module 930. In some embodiments, based on the analysis of the buildcard information, which defines the one or more attributes of the software application, functions and properties of the software application are determined by the metadata generator module 930.

At step 1215, the process 1200 may determine one or more third-party applications utilized by the software application based on the determined functions and properties. In some embodiments, the one or more third-party applications utilized by the software application are determined by the metadata generator module 930 based on the determined functions and properties. For example, the software application may utilize the third-party application (such as a payment gateway application) to enable the payment transaction in the software application, such third-party applications are determined by the metadata generator module 930.

At step 1220, the process 1200 may generate metadata for the software application based on the determined one or more third-party applications and the determined functions and properties. In some embodiments, the metadata for the software application is generated by the metadata generator module 930 based on the determined one or more third-party applications and the determined functions and properties. In some embodiments, upon determining the functions and properties of the software application, the metadata for the software application is generated by the metadata generator module 930.

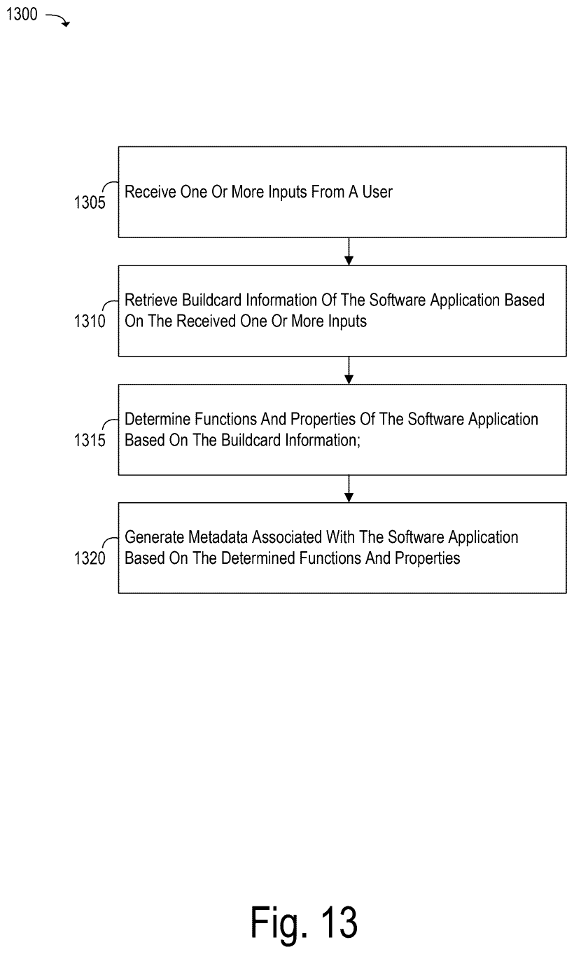

Referring to FIG. 13, FIG. 13 is a flow diagram for another embodiment of the disclosed subject matter for a process 1300 of generating metadata for the software application.

At step 1305, the process 1300 may receive an input from a user to publish the software application to the one or more application stores. In some embodiments, the one or more inputs are received from the user by the receiving module 925. In some embodiments, the one or more inputs are received by the receiving module 925 when the user clicks on an icon to publish the software application to the one or more application stores 920. In some embodiments, the one or more inputs are received by the receiving module 925 when the user manually enters the one or more inputs on a user interface associated with the metadata generator system 900. The one or more inputs may include at least one of: software application details (such as a software application ID and a software application name) and user credentials for the software application.

At step 1310, the process 1300 may retrieve buildcard information of the software application based on the received input. In some embodiments, the buildcard information of the software application is retrieved based on the received input by the receiving module. In some embodiments, in order to retrieve the buildcard information, a database or repository storing buildcards related to various software applications is accessed by the receiving module 925.

At step 1315, the process 1300 may determine functions and properties of the software application based on the buildcard information. In some embodiments, the functions and the properties of the software application are determined by the metadata generator module 930. In some embodiments, based on the analysis of the buildcard information, which defines the one or more attributes of the software application, functions and properties of the software application are determined by the metadata generator module 930.

At step 1320, the process 1300 may generate the metadata associated with the software application. In some embodiments, the metadata for the software application is generated by the metadata generator module 930 based on the determined functions and properties.

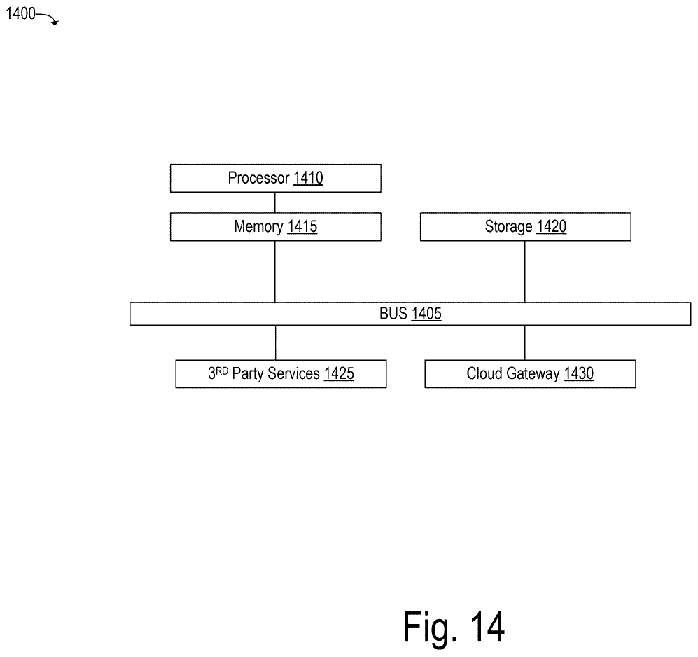

Referring to FIG. 14, FIG. 14 is a schematic illustrating a computing system 1400 that may be used to implement various features of embodiments described in the disclosed subject matter. The terms components, entities, modules, surface, and platform, when used herein, may refer to one of the many embodiments of a computing system 1400. The computing system 1400 may be a single computer, a co-located computing system, a cloud-based computing system, or the like. The computing system 1400 may be used to carry out the functions of one or more of the features, entities, and/or components of a software project.

The exemplary embodiment of the computing system 1400 shown in FIG. 14 includes a bus 1405 that connects the various components of the computing system 1400, one or more processors 1410 connected to a memory 1415, and at least one storage 1420. The processor 1410 is an electronic circuit that executes instructions that are passed to it from the memory 1415. Executed instructions are passed back from the processor 1410 to the memory 1415. The interaction between the processor 1410 and memory 1415 allow the computing system 1400 to perform computations, calculations, and various computing to run software applications.

Examples of the processor 1410 include central processing units (CPUs), graphics processing units (GPUs), field programmable gate arrays (FPGAs), complex programmable logic devices (CPLDs), and application specific integrated circuits (ASICs). The memory 1415 stores instructions that are to be passed to the processor 1410 and receives executed instructions from the processor 1410. The memory 1415 also passes and receives instructions from all other components of the computing system 1400 through the bus 1405. For example, a computer monitor may receive images from the memory 1415 for display. Examples of memory include random access memory (RAM) and read only memory (ROM). RAM has high speed memory retrieval and does not hold data after power is turned off. ROM is typically slower than RAM and does not lose data when power is turned off.

The storage 1420 is intended for long term data storage. Data in the software project such as computer readable specifications, code, designs, and the like may be saved in a storage 1420. The storage 1420 may be stored at any location including in the cloud. Various types of storage include spinning magnetic drives and solid-state storage drives.

The computing system 1400 may connect to other computing systems in the performance of a software project. For instance, the computing system 1400 may send and receive data from 3^{rd} party services such as Office 365 and Adobe. Similarly, users may access the computing system 1400 via a cloud gateway 1430. For instance, a user on a separate computing system may connect to the computing system 1400 to access data, interact with the run entities 108, and even use 3^{rd} party services 1425 via the cloud gateway.

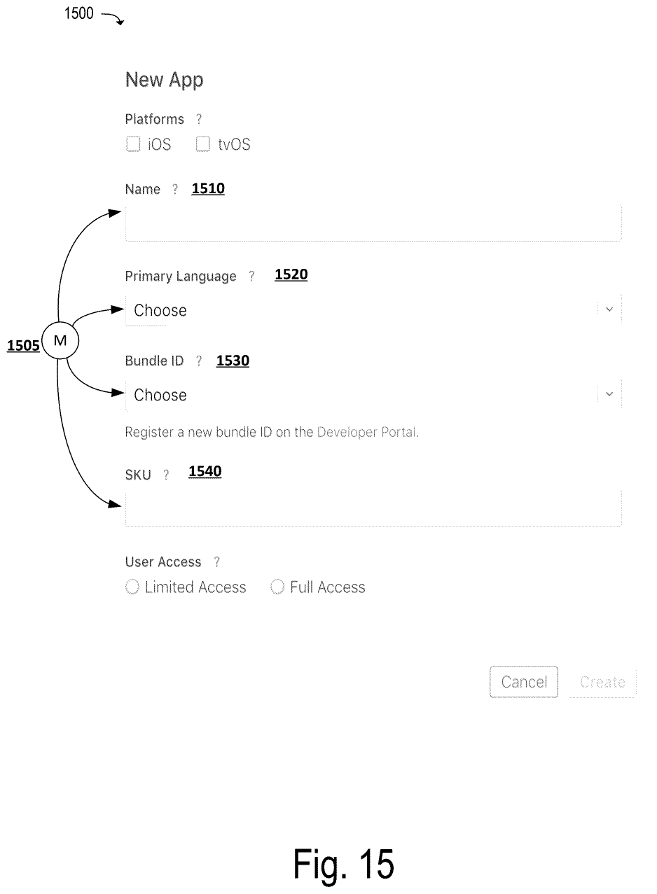

Referring to FIG. 15, FIG. 15 is an example user interface associated with a user device to auto-fill the submission form associated with one of the application stores.

The user interface 1500 associated with a user device to auto-fill the submission form associated with one of the application stores is shown. The user interface also comprises metadata icon 1505, which comprises the necessary data to auto-fill the submission form associated with the one or more application stores 920.

Upon navigating to the submission form associated with one of the application stores, the user device may pop up the metadata icon 1505. The metadata icon 1505 may generally store the metadata generated. For example, the metadata icon 1505 may store the metadata generated when the developer clicks on the metadata generator icon 1005 as shown in FIG. 10.

Further, upon clicking the metadata icon 1505, the user device may identify one or more fields in the submission form. In some embodiments, the one or more fields are identified using the OCR technology. As shown in FIG. 15, the submission form may include the name of the software application 1510, the primary language 1520 of the software application, bundle ID 1530, and Stock Keeping Unit (SKU) 1540. Once the one or more fields are identified, the user device may extract the data corresponding to various fields in the submission form from the metadata icon 1505 and auto-fill the name 1510 field, primary language 1520 field, bundle ID 1530 field, and SKU 1540 field, thereby enabling the auto-submission of various forms without any manual effort.

A method for submission of a software application to one or more application stores includes receiving one or more inputs from a user and determining requirements to submit the software application to the one or more application stores based on the received one or more inputs. The method further includes generating metadata for the software application based on the determined requirements and submitting the software application to the one or more application stores based on the generated metadata. The method may include generating the metadata for the software application by analyzing one or more attributes of the software application, where the attributes may include initial inputs provided by a client to develop the software application, one or more documents provided by the client, feedback from the client during the software application development process, and source codes related to the software application. The method may include determining the requirements to submit the software application to the one or more application stores by connecting to the one or more application stores through Application Program Interfaces (APIs) to retrieve the requirements. The method may include generating the metadata for the software application by determining functions and properties of the software application based on the analysis, and generating the metadata based on the determined functions and properties. The metadata may include a software application description, keywords that define the software application, screenshots of the software application, an application icon for the software application, title of the software application, and privacy policy information of the software application. The method may include submitting the software application to the one or more application stores by creating a developer account associated with the one or more application stores. The method may further include validating the generated metadata against submission requirements of the one or more application stores before submitting the software application.

A computer system for submitting a software application to one or more application stores includes a processor coupled to a memory. The processor is configured to execute software to receive one or more inputs from a user, determine requirements to submit the software application to the one or more application stores based on the received one or more inputs, generate metadata for the software application based on the determined requirements, and submit the software application to the one or more application stores based on the generated metadata. To generate the metadata for the software application, the processor may be configured to analyze one or more attributes of the software application, where the attributes may include initial inputs provided by a client to develop the software application, one or more documents provided by the client, feedback from the client during the software application development process, and source codes related to the software application. To determine the requirements to submit the software application to the one or more application stores, the processor may be configured to connect to the one or more application stores through Application Program Interfaces (APIs) to retrieve the requirements. To generate the metadata, the processor may be configured to determine functions and properties of the software application and generate the metadata based on the determined functions and properties. The metadata may include a software application description, keywords that define the software application, screenshots of the software application, an application icon for the software application, title of the software application, and privacy policy information of the software application. To submit the software application to the one or more application stores based on the generated metadata, the processor may be configured to create a developer account associated with the one or more application stores. The processor may be further configured to validate the generated metadata against submission requirements of the one or more application stores before submitting the software application.

A computer-readable storage medium has data stored in it representing software executable by a computer. The software includes instructions that, when executed, cause the computer to receive one or more inputs from a user, determine requirements to submit the software application to the one or more application stores based on the received one or more inputs, generate metadata for the software application based on the determined requirements, and submit the software application to the one or more application stores based on the generated metadata. The software may include generating the metadata for the software application by analyzing one or more attributes of the software application, where the attributes may include initial inputs provided by a client to develop the software application, one or more documents provided by the client, feedback from the client during the software application development process, and source codes related to the software application. The software may include determining the requirements to submit the software application to the one or more application stores by connecting to the one or more application stores through Application Program Interfaces (APIs) to retrieve the requirements. The software may include generating the metadata for the software application by determining functions and properties of the software application based on the analysis, and generating the metadata based on the determined functions and properties. The metadata may include a software application description, keywords that define the software application, screenshots of the software application, an application icon for the software application, title of the software application, and privacy policy information of the software application. The software may include submitting the software application to the one or more application stores by creating a developer account associated with the one or more application stores.

A method for generating metadata for a software application includes receiving buildcard information of the software application and determining functions and properties of the software application based on the buildcard information. The method further includes determining one or more third-party applications utilized by the software application based on the determined functions and properties and generating the metadata associated with the software application based on the determined one or more third-party applications and the determined functions and properties. The method may include determining the functions and properties of the software application by analyzing the buildcard information using a large language model. The metadata may include a software application description, keywords that define the software application, screenshots of the software application, an application icon for the software application, title of the software application, and privacy policy information of the software application. The method may include generating the metadata by creating an application icon and one or more screenshots of the software application. The method may further include validating the generated metadata against submission requirements of the one or more application stores before submitting the software application. The method may include submitting the software application to one or more application stores using the generated metadata. Submitting the software application to one or more application stores may include automatically filling out submission forms using the generated metadata.

A computer system for generating metadata for a software application includes a processor coupled to a memory. The processor is configured to execute software to receive buildcard information related to the software application, determine functions and properties of the software application based on the buildcard information, determine one or more third-party applications utilized by the software application based on the determined functions and properties; and generate the metadata associated with the software application based on the determined one or more third-party applications and the determined functions and properties. To determine the functions and properties of the software application, the processor may be configured to analyze the buildcard information using a large language model. The metadata may include a software application description, keywords that define the software application, screenshots of the software application, an application icon for the software application, title of the software application, and privacy policy information of the software application. To generate the metadata, the processor may be configured to generate an application icon and one or more screenshots of the software application. The processor may be further configured to validate the generated metadata against submission requirements of one or more application stores before submitting the software application and submit the software application to one or more application stores using the generated metadata. To submit the software application to the one or more application stores, the processor may be configured to automatically fill out submission forms using the generated metadata.

A computer-readable storage medium has data stored in it representing software executable by a computer. The software includes instructions that, when executed, cause the computer to receive buildcard information related to the software application, determine functions and properties of the software application based on the buildcard information, determining one or more third-party applications utilized by the software application based on the determined functions and properties, and generating metadata associated with the software application based on the determined one or more third-party applications and the determined functions and properties. The software may include determining the functions and properties of the software application by analyzing the buildcard information using a large language model. The metadata may include a software application description, keywords that define the software application, screenshots of the software application, an application icon for the software application, title of the software application, and privacy policy information of the software application. The software may include generating the metadata by creating an application icon and one or more screenshots of the software application. The software may further include validating the generated metadata against submission requirements of the one or more application stores before submitting the software application. The software may include submitting the software application to one or more application stores using the generated metadata. Submitting the software application to one or more application stores may include automatically filling out submission forms using the generated metadata.

A method for generating metadata for a software application includes receiving one or more inputs from a user and retrieving buildcard information of the software application based on the received inputs. The method further includes determining functions and properties of the software application based on the buildcard information and generating the metadata for the software application based on the determined functions and properties. The method may include determining the functions and properties of the software application by analyzing the buildcard information using a large language model. Retrieving the buildcard information may include accessing a database storing buildcards of one or more software applications. The method may include generating the metadata by generating icons and screenshots based on the determined functions and properties of the software application. The method may further include submitting the software application to one or more application stores using the generated metadata. The method may include validating the generated metadata against submission requirements of the one or more application stores before submitting the software application. Validating may include verifying compliance with format specifications, content guidelines, and other criteria specified by the one or more application stores.

A computer system for generating metadata for a software application includes a processor coupled to a memory. The processor is configured to execute software to receive an input from a user to publish the software application to one or more application stores, retrieve buildcard information related to the software application based on the received input, determine functions and properties of the software application based on the buildcard, and generate the metadata associated with the software application based on the determined functions and properties. To determine the functions and properties of the software application, the processor may be configured to analyze the buildcard information using a large language model. To retrieve the buildcard information, the processor may be configured to access a database storing buildcards of one or more software applications. To generate the metadata, the processor may be configured to generate icons and screenshots based on the determined functions and properties of the software application. The processor may be further configured to submit the software application to one or more application stores using the generated metadata. The processor may be further configured to validate the generated metadata against submission requirements of the one or more application stores before submitting the software application. To validate, the processor may be configured to verify compliance with format specifications, content guidelines, and other criteria specified by the one or more application stores.

A computer-readable storage medium has data stored in it representing software executable by a computer. The software includes instructions that, when executed, cause the computer to receive an input from a user to publish the software application to one or more application stores, retrieve buildcard information related to the software application based on the received input, determine functions and properties of the software application based on the buildcard, and generate metadata associated with the software application based on the determined functions and properties. The software may include determining the functions and properties of the software application by analyzing the buildcard information using a large language model. Retrieving the buildcard information may include accessing a database storing buildcards of one or more software applications. The software may include generating the metadata by generating icons and screenshots based on the determined functions and properties of the software application. The software may further include submitting the software application to one or more application stores using the generated metadata. The software may include validating the generated metadata against submission requirements of the one or more application stores before submitting the software application. Validating may include verifying compliance with format specifications, content guidelines, and other criteria specified by the one or more application stores.

Many variations may be made to the embodiments of the software project described herein. All variations, including combinations of variations, are intended to be included within the scope of this disclosure. The description of the embodiments herein can be practiced in many ways. Any terminology used herein should not be construed as restricting the features or aspects of the disclosed subject matter. The scope should instead be construed in accordance with the appended claims.

1. A method for generating metadata for a software application, comprising:
receiving one or more inputs from a user;
retrieving buildcard information of the software application based on the received one or more inputs;
determining functions and properties of the software application based on the buildcard information; and
generating the metadata for the software application based on the determined functions and properties.

2. The method of claim 1, wherein determining the functions and properties of the software application comprises analyzing the buildcard information using one of a large language model and a short language model.

3. The method of claim 1, wherein retrieving the buildcard information comprises accessing a database storing buildcards of one or more software applications.

4. The method of claim 1, wherein generating the metadata comprises generating icons and screenshots based on the determined functions and properties of the software application.

5. The method of claim 1, further comprising:
submitting the software application to one or more application stores using the generated metadata.

6. The method of claim 1, further comprising:
validating the generated metadata against submission requirements of one or more application stores before submitting the software application.

7. The method of claim 6, wherein validating comprises verifying compliance with format specifications, content guidelines, and other criteria specified by the one or more application stores.

8. A computer system to generate metadata for a software application, the computer system comprising:
a processor coupled to a memory, the processor configured to execute a software to perform:
receive one or more inputs from a user;
retrieve buildcard information of the software application based on the received one or more inputs;
determine functions and properties of the software application based on the buildcard information; and
generate the metadata for the software application based on the determined functions and properties.

9. The computer system of claim 8, wherein to determine the functions and properties of the software application, the processor is configured to analyze the buildcard information using one of a large language model and a short language model.

10. The computer system of claim 8, wherein to retrieve the buildcard information, the processor is configured to access a database buildcards of one or more software applications.

11. The computer system of claim 8, wherein to generate the metadata, the processor is configured to generate icons and screenshots based on the determined functions and properties of the software application.

12. The computer system of claim 8, wherein the processor is further configured to:
submit the software application to one or more application stores using the generated metadata.

13. The computer system of claim 8, wherein the processor is further configured to:
validate the generated metadata against submission requirements of one or more application stores before submitting the software application.

14. The computer system of claim 13, wherein to validate, the processor is configured to:
verify compliance with format specifications, content guidelines, and other criteria specified by the one or more application stores.

15. A computer readable storage medium having data stored therein representing software executable by a computer, the software comprising instructions that, when executed, cause the computer readable storage medium to perform:
receiving one or more inputs from a user;
retrieving buildcard information of a software application based on the received one or more inputs;
determining functions and properties of the software application based on the buildcard information; and
generating metadata for the software application based on the determined functions and properties.

16. The computer readable storage medium of claim 15, wherein determining the functions and properties of the software application comprises analyzing the buildcard information using one of a large language model and a short language model.

17. The computer readable storage medium of claim 15, wherein retrieving the buildcard information comprises accessing a database storing buildcards of one or more software applications.

18. The computer readable storage medium of claim 15, wherein generating the metadata comprises generating icons and screenshots based on the determined functions and properties of the software application.

19. The computer readable storage medium of claim 15, further comprising:
submitting the software application to one or more application stores using the generated metadata.

20. The computer readable storage medium of claim 15, further comprising:
validating the generated metadata against submission requirements of one or more application stores before submitting the software application.
